(19) United States
(12) Patent Application Publication
(10) Pub. No.: US 2013/0244568 A1
(43) Pub. Date: Sep. 19, 2013

(54) COMMUNICATION SYSTEM AND TEST APPARATUS

(71) Applicant: ADVANTEST CORPORATION, Tokyo (JP)

(72) Inventor: Kazumoto TAMURA, Gunma (JP)

(73) Assignee: ADVANTEST CORPORATION, Tokyo (JP)

(21) Appl. No.: 13/861,391

(22) Filed: Apr. 12, 2013

Related U.S. Application Data
(63) Continuation of application No. PCT/JP2011/002007, filed on Apr. 4, 2011.

(51) Int. Cl. H04W 76/02

(52) U.S. Cl. CPC H04W 76/02
USPC 455/7

(57) ABSTRACT

A test apparatus ensures to establish communication. A test apparatus including a first communication apparatus and a second communication apparatus, where the transmitting section of the first communication apparatus transmits the first linkup code to the receiving section of the second communication apparatus, the transmitting section of the second communication apparatus transmits, instead of the first linkup code, the second linkup code in response to communication having being established between the receiving section of the second communication apparatus and the transmitting section of the first communication apparatus, and the receiving section of the first communication apparatus starts communicating with the transmitting section of the relay apparatus, in response to communication having being established with the transmitting section of the relay apparatus and reception of the second linkup code from the transmitting section of the relay apparatus.

### BACKGROUND

1. TECHNICAL FIELD

The present invention relates to a communication system and a test apparatus.

2. Related Art

Before starting transmission or reception of data, communications systems of serial signals execute linkup process such as clock recovery, word alignment or the like to both of the uplink line and the downlink line. More specifically, the transmission module of one communication apparatus will transmit predetermined data used for linkup process, and the reception module of the other communication apparatus will perform the linkup process.

However, the transmission module of one communication apparatus cannot know whether the reception module of the other communication apparatus has completed the linkup process. Therefore, the one communication apparatus will presume that the linkup process of the other communication apparatus has completed after a predetermined time has passed after transmission of the linkup data, and stops transmitting the linkup data. However, if the power supplies of the two communication apparatuses are turned ON at greatly different timings, it is possible that the other communication apparatus has not actually completed the linkup process even though the predetermined time has passed.

The normal code transmitted and received after completion of the linkup process may also have a data pattern adaptable for linkup process. So even when the linkup process is not completed within the predetermined time, the normal code can eventually complete the linkup process. However, in this case, the part of the normal code that has been transmitted before completion of the linkup process will be left unexecuted, and therefore there is a chance that commands will be dropped.

### SUMMARY

Therefore, it is an object of an aspect of the innovations herein to provide a communication system and a test apparatus, which are capable of overcoming the above drawbacks accompanying the related art. The above and other objects can be achieved by combinations described in the claims. According to a first aspect of the present invention, provided is a communication system including a first communication apparatus and a second communication apparatus, where each of the first communication apparatus and the second communication apparatus includes a transmitting section that transmits a signal to another apparatus at the other end, and a receiving section that receives the signal from the other apparatus at the other end, the transmitting section of the first communication apparatus transmits a first linkup code for establishing communication to the receiving section of the second communication apparatus, the transmitting section of the second communication apparatus transmits the first linkup code to the receiving section of the first communication apparatus, the receiving section of the second communication apparatus receives the first linkup code and executes establishing a process of the communication with the transmitting section of the first communication apparatus, the transmitting section of the second communication apparatus transmits, instead of the first linkup code, the second linkup code for establishing the communication, which has a pattern different from a pattern of the first linkup code, in response to communication being established between the receiving section of the second communication apparatus and the transmitting section of the first communication apparatus, the receiving section of the first communication apparatus receives either the first linkup code or the second linkup code and executes establishing a process of the communication with the transmitting section of the second communication apparatus, and the receiving section of the first communication apparatus starts communicating with the transmitting section of the second communication apparatus, in response to the communication being established with the transmitting section of the second communication apparatus and the reception of the second linkup code from the transmitting section of the second communication apparatus.

According to a second aspect of the present invention, provided is a test apparatus for testing a device under test, including: a test unit that tests the device under test by exchanging a signal with the device under test; a control apparatus that controls the test unit; and a relay apparatus that relays communication performed between the test unit and the control apparatus, where each of the relay apparatus and the test unit includes: a transmitting section that transmits a signal to a communication apparatus at another end; and a receiving section that receives a signal from the communication apparatus at the other end, the transmitting section of the relay apparatus transmits a first linkup code for establishing communication to the receiving section of the test unit, the transmitting section of the test unit transmits the first linkup code to the receiving section of the relay apparatus, the receiving section of the test unit receives the first linkup code, and performs a process to establish communication with the transmitting section of the relay apparatus, the transmitting section of the test unit transmits, instead of the first linkup code, a second linkup code for establishing communication, which is different from the first linkup code, in response to communication being established between the receiving section of the test unit and the transmitting section of the relay apparatus, the receiving section of the relay apparatus receives either the first linkup code or the second linkup code, and performs a process to establish communication with the transmitting section of the test unit, and the receiving section of the relay apparatus starts communication with the transmitting section of the test unit, in response to communication being established with the transmitting section of the test unit and reception of the second linkup code from the transmitting section of the test unit.

The summary clause does not necessarily describe all necessary features of the embodiments of the present invention. The present invention may also be a sub-combination of the features described above.

### BRIEF DESCRIPTION OF THE DRAWINGS

FIG. 1 shows a configuration of a test apparatus 10 according to the present embodiment.

FIG. 2 shows a configuration of a communication apparatus 20 included in each of a test unit 12 and a relay apparatus 16.

FIG. 3 shows a flow of linkup process performed between a first communication apparatus 20-1 and a second communication apparatus 20-2.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

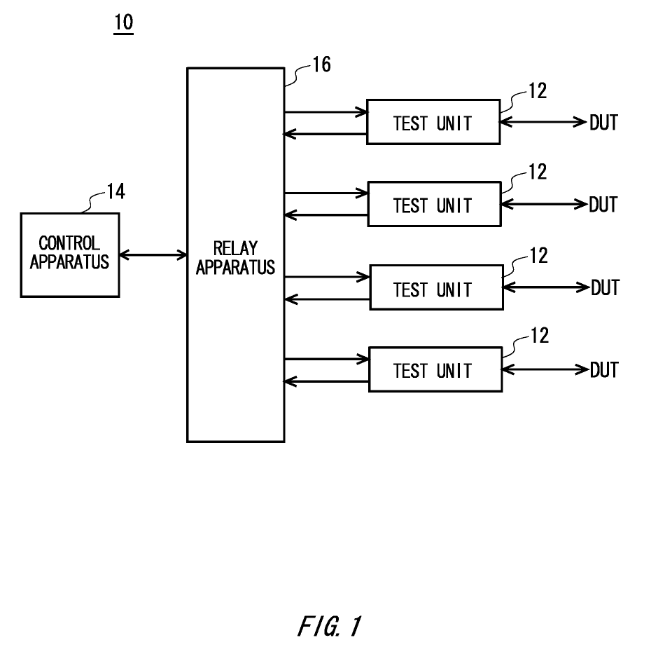

FIG. 1 shows a configuration of a test apparatus 10 according to the present embodiment. The test apparatus 10 tests a device under test (DUT) such as a semiconductor apparatus or the like. The test apparatus 10 includes one or more test units 12, a control apparatus 14, and a relay apparatus 16.

Each test unit 12 exchanges signals with a device under test. In an example, the test unit 12 supplies, to the device under test, a test signal having a waveform corresponding to a test pattern, and compares the response signal from the device under test with the logical value corresponding to the pattern of the expected value, thereby judging whether the device under test is good or bad.

The control apparatus 14 supplies a command to each of the one or more test units 12, to control the test unit 12. In an example, the control apparatus 14 is realized by a computer functioning as the control apparatus 14 by executing a program.

The relay apparatus 16 relays a command and a response between the control apparatus 14 and each of the one or more test units 12. The control apparatus 14 and the relay apparatus 16 are connected by Ethernet or the like. A serial signal is transmitted between the relay apparatus 16 and each test unit 12.

In the present embodiment, the serial signal transmitted between the relay apparatus 16 and each test unit 12 is compliant with a high-speed serial transmission standard called 8b/10b (or 10b/8b), but may be a signal in compliance with other standards such as USB3.0, PCIExpress or the like. A similar serial signal can also be transmitted between the control apparatus 14 and the relay apparatus 16.

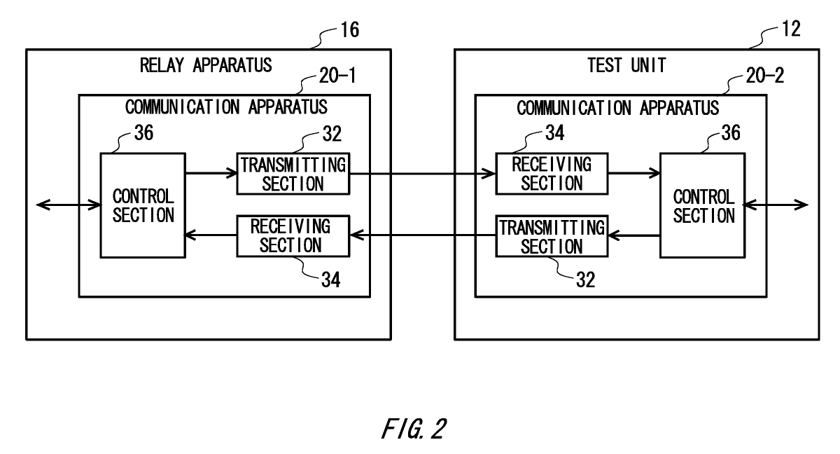

FIG. 2 shows a configuration of a communication apparatus 20 included in each of a test unit 12 and a relay apparatus 16. Each test unit 12 includes a communication apparatus 20 for performing serial communication with the relay apparatus 16. The relay apparatus 16 includes a communication apparatus 20 for each of one or more test units 12, for performing serial communication with the corresponding test unit 12.

Each communication apparatus 20 included in the one or more test units 12 and the relay apparatus 16 includes a transmitting section 32, a receiving section 34, and a control section 36.

The transmitting section 32 transmits a serial signal in compliance with the 8b/10b standard to the communication apparatus 20 at the other end. The receiving section 34 receives a serial signal in compliance with the 8b/10b standard from the communication apparatus 20 at the other end. The control section 36 controls the transmission and reception operation of the transmitting section 32 and the receiving section 34.

Here, with the 8b/10b standard, signals are transmitted and received by converting data of 8 bits to data of 10 bits. With the 8b/10b standard, conversion or inverse conversion of data of 8 bits to data of 10 bits is performed by referring a table. With the 8b/10b standard, the code of 10 bits for transmitting information to the other end during normal data transmission/reception is referred to as “D code.”

In addition, with the 8b/10b standard, a clock is embedded in a serial signal transmitted and received. Therefore, with the 8b/10b standard, prior to transmission or reception of data (D code), the transmitting section 32 transmits a K code, which is a predetermined control code, and the receiving section 34 executes clock recovery process and word alignment process.

The clock recovery process is to reproduce a clock from a serial signal. The word alignment process is to detect a word portion to be singled out from the data sequence transmitted as a serial signal. For example, the receiving section 34 can execute the word alignment process by matching the data pattern stored in advance and the data sequence of the serial signal transmitted from the transmitting section 32.

Note that the process performed in communication initialization, which includes the clock recovery process and the word alignment process, is referred to as “linkup process.” The receiving section 34 can establish communication with the transmitting section 32, by executing such linkup process.

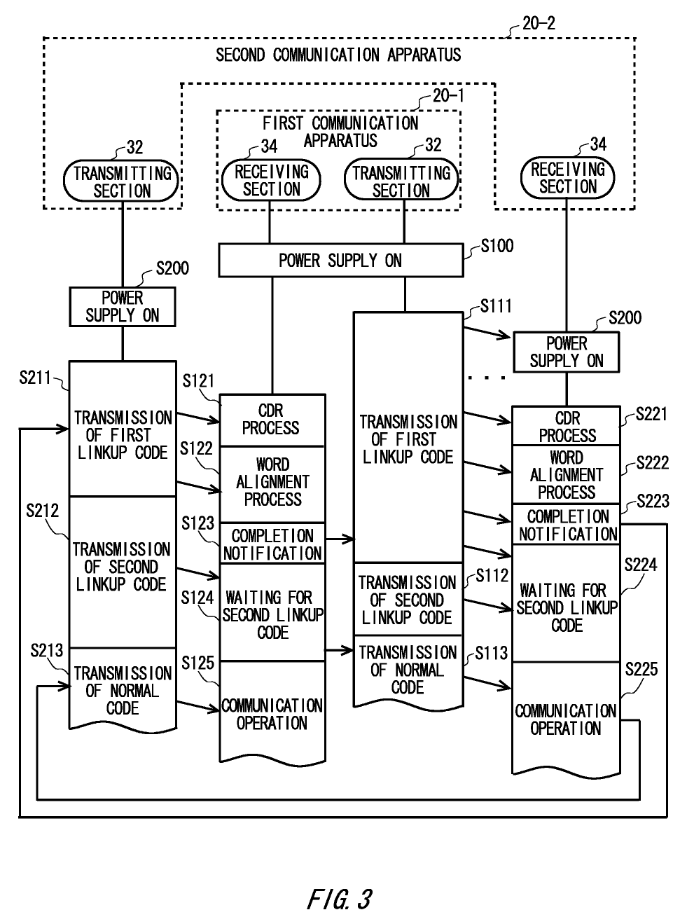

FIG. 3 shows a flow of linkup process performed between a first communication apparatus 20-1 and a second communication apparatus 20-2. FIG. 3 specifically shows a flow of linkup process performed between a single test unit 12 and the relay apparatus 16. Hereinafter, the communication apparatus 20 included in one of the single test unit 12 and the relay apparatus 16 is referred to as “first communication apparatus 20-1” and the communication apparatus 20 included in the other is referred to as “second communication apparatus 20-2.”

First, the power supply of the first communication apparatus 20-1 is turned ON (S100). The power supply of the second communication apparatus 20-2 is also turned ON (S200). Note that the first communication apparatus 20-1 and the second communication apparatus 20-2 may have their respective power supplies turned ON at different timings from each other. In the example of FIG. 3, the power supply of the second communication apparatus 20-2 is turned ON after a predetermined time has passed after the power supply of the first communication apparatus 20-1 is turned ON.

After the power supply of the first communication apparatus 20-1 is turned ON, the transmitting section 32 of the first communication apparatus 20-1 transmits the first linkup code for establishing communication to the receiving section 34 of the second communication apparatus 20-2 (S111). In an example, the first linkup code is a K code conforming to the 8b/10b standard. In this case, the transmitting section 32 of the first communication apparatus 20-1 repeatedly transmits the first linkup code.

Next, in response to the turning ON of the power supply of the second communication apparatus 20-2, the receiving section 34 of the second communication apparatus 20-2 receives the first linkup code transmitted from the transmitting section 32 of the first communication apparatus 20-1, and executes the establishing process of the communication with the transmitting section 32 of the first communication apparatus 20-1. More specifically, the receiving section 34 of the second communication apparatus 20-2 first refers to the first linkup code and executes clock recovery process (clock data recovery: CDR) (S221). After completion of the clock recovery process, the receiving section 34 of the second communication apparatus 20-2 refers to the first linkup code and executes word alignment process (S222). As a result, the receiving section 34 of the second communication apparatus 20-2 can establish communication with the transmitting section 32 of the first communication apparatus 20-1.

Subsequently, the receiving section 34 of the second communication apparatus 20-2 supplies a notification that communication has been established, to the transmitting section 32 of the second communication apparatus 20-2 (S223). If not having received the second linkup code even after communication being established with the transmitting section 32 of the first communication apparatus 20-1, the receiving section 34 of the second communication apparatus 20-2 suspends the process until receiving the second linkup code from the transmitting section 32 of the first communication apparatus 20-1 (S224).

After the power supply of the second communication apparatus 20-2 is turned ON, the transmitting section 32 of the second communication apparatus 20-2 transmits the first linkup code to the receiving section 34 of the first communication apparatus 20-1, (S211). In this case, the transmitting section 32 of the second communication apparatus 20-2 repeatedly transmits the first linkup code.

Here, when the receiving section 34 of the second communication apparatus 20-2 has received a notification that the receiving section 34 of the second communication apparatus 20-2 has established communication with the transmitting section 32 of the first communication apparatus 20-1, while the transmitting section 32 of the second communication apparatus 20-2 is repeatedly transmitting the first linkup code (S211), the transmitting section 32 of the second communication apparatus 20-2 transmits the second linkup code instead of the first linkup code (S212). In this case, the transmitting section 32 of the second communication apparatus 20-2 repeatedly transmits the second linkup code.

The second linkup code is a code to establish communication, and has a pattern different from the pattern of the first linkup code. Specifically, the second linkup code is obtained by inserting a code with a pattern for transmitting information to the communication apparatus 20 at the other end, into a code with a pattern for establishing communication.

An exemplary second linkup code is a code containing a D code in the data sequence of a sequence of K codes with a predetermined ratio. By referring to such a second linkup code, the receiving section 34 can execute the clock recovery process and the word alignment process as well as recognize that it has received data having a pattern different from the first linkup code.

In response to the turning ON of the power supply of the first communication apparatus 20-1, the receiving section 34 of the first communication apparatus 20-1 receives either the first linkup code or the second linkup code, and executes establishing a process of communication with the transmitting section 32 of the second communication apparatus 20-2. Specifically, the receiving section 34 of the first communication apparatus 20-1 refers to the first linkup code or the second linkup code and executes the clock recovery process (S121). After completion of the clock recovery process, the receiving section 34 of the first communication apparatus 20-1 refers to either the first linkup code or the second linkup code and executes word alignment process (S122). As a result, the receiving section 34 of the first communication apparatus 20-1 can establish communication with the transmitting section 32 of the second communication apparatus 20-2.

After completion of communication being established with the transmitting section 32 of the second communication apparatus 20-2, the receiving section 34 of the first communication apparatus 20-1 supplies a notification that communication has been established, to the transmitting section 32 of the first communication apparatus 20-1 (S123). If not having received the second linkup code even after communication has been established with the transmitting section 32 of the second communication apparatus 20-2, the receiving section 34 of the first communication apparatus 20-1 suspends the process until receiving the second linkup code from the transmitting section 32 of the second communication apparatus 20-2 (S 124).

In response to reception of the second linkup code from the transmitting section 32 of the second communication apparatus 20-2, the receiving section 34 of the first communication apparatus 20-1 supplies a notification of reception of the second linkup code to the transmitting section 32 of the first communication apparatus 20-1. Then, the receiving section 34 of the first communication apparatus 20-1 starts communicating with the transmitting section 32 of the second communication apparatus 20-2, in response to communication being established with the transmitting section 32 of the second communication apparatus 20-2, as well as reception of the second linkup code from the transmitting section 32 of the second communication apparatus 20-2 (S125).

While repeatedly transmitting the first linkup code (S111), when the transmitting section 32 of the first communication apparatus 20-1 has received a notification that communication has been established between the receiving section 34 of the first communication apparatus 20-1 and the transmitting section 32 of the second communication apparatus 20-2, the transmitting section 32 of the first communication apparatus 20-1 transmits the second linkup code instead of the first linkup code (S112). In this case, the transmitting section 32 of the first communication apparatus 20-1 repeatedly transmits the second linkup code.

While repeatedly transmitting the second linkup code (S112), when the transmitting section 32 of the first communication apparatus 20-1 has received a notification that the receiving section 34 of the first communication apparatus 20-1 has received the second linkup code from the transmitting section 32 of the second communication apparatus 20-2, it then transmits a normal code to the receiving section 34 of the second communication apparatus 20-2 hereafter (S113).

In response to reception of the second linkup code from the transmitting section 32 of the first communication apparatus 20-1, the receiving section 34 of the second communication apparatus 20-2 supplies a notification indicating that the second linkup code has been received, to the transmitting section 32 of the second communication apparatus 20-2. Then, the receiving section 34 of the second communication apparatus 20-2 starts communicating with the transmitting section 32 of the first communication apparatus 20-1 in response to communication being established with the transmitting section 32 of the first communication apparatus 20-1 and the second linkup code being received from the transmitting section 32 of the first communication apparatus 20-1 (S225).

While repeatedly transmitting the second linkup code (S212), when the transmitting section 32 of the second communication apparatus 20-2 has received a notification that communication has been established between the receiving section 34 of the second communication apparatus 20-2 and the transmitting section 32 of the first communication apparatus 20-1, it then transmits a normal code to the receiving section 34 of the first communication apparatus 20-1 hereafter (S213).

According to the stated processes, the first communication apparatus 20-1 and the second communication apparatus 20-2 can perform linkup process to transmit a serial signal from the respective transmissions 32 to the other receiving sections 24. When the receiving section 34 of a communication apparatus 20 has established communication, the transmitting section 32 of the same communication apparatus 20 changes the contents of the linkup code that it transmits. A receiving section 34 in a communication apparatus 20 has detected change in contents of a linkup code, the receiving section 34 notifies the same to the transmitting section 32 of the same communication apparatus 20.

Accordingly, the transmitting section 32 of the first communication apparatus 20-1 and the second communication apparatus 20-2 can each be aware that the receiving section 34 of the communication apparatus 20 at the other end has established communication. Therefore, the first communication apparatus 20-1 and the second communication apparatus 20-2 can start communicating after the communication establishing process is reliably completed. Furthermore, the first communication apparatus 20-1 and the second communication apparatus 20-2 need not provide a process margin for the reliable completion of the communication establishing process, and therefore communication can be begun after a short time Yet further, even when the timing at which the power supply is turned ON is different for the first communication apparatus 20-1 and the second communication apparatus 20-2, the communication establishing process can proceed by synchronizing the apparatuses.

When serial communication is performed using a plurality of protocols having a hierarchical structure, the first communication apparatus 20-1 and the second communication apparatus 20-2 may perform the above communication process at each stage of the hierarchy. As a result, the first communication apparatus 20-1 and the second communication apparatus 20-2 can perform the communication establishing process sequentially, one stage at a time, from the lower level stages, while synchronizing the uplink line and the downlink line with each other.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with sub-combinations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A test apparatus for testing a device under test, comprising:
a test unit that tests the device under test by exchanging a signal with the device under test;
a control apparatus that controls the test unit; and
a relay apparatus that relays communication performed between the test unit and the control apparatus, wherein
each of the relay apparatus and the test unit includes:
a transmitting section that transmits a signal to a communication apparatus at another end; and
a receiving section that receives a signal from the communication apparatus at the other end,
the transmitting section of the relay apparatus transmits a first linkup code for establishing communication to the receiving section of the test unit,
the transmitting section of the test unit transmits the first linkup code to the receiving section of the relay apparatus,
the receiving section of the test unit receives the first linkup code, and performs a process to establish communication with the transmitting section of the relay apparatus,
the transmitting section of the test unit transmits, instead of the first linkup code, a second linkup code for establishing communication, which is different from the first linkup code, in response to communication being established between the receiving section of the test unit and the transmitting section of the relay apparatus,
the receiving section of the relay apparatus receives either the first linkup code or the second linkup code, and performs a process to establish communication with the transmitting section of the test unit, and
the receiving section of the relay apparatus starts communication with the transmitting section of the test unit, in response to communication being established with the transmitting section of the test unit and reception of the second linkup code from the transmitting section of the test unit.

2. The test apparatus according to claim 1, wherein
the receiving section of the relay apparatus receives the first linkup code and executes a process to establish communication with the transmitting section of the test unit,
the transmitting section of the relay apparatus transmits the second linkup code instead of the first linkup code, in response to communication being established between the receiving section of the relay apparatus and the transmitting section of the test unit,
the receiving section of the test unit receives either the first linkup code or the second linkup code, and executes a process to establish communication with the transmitting section of the relay apparatus, and
the receiving section of the test unit starts communicating with the transmitting section of the relay apparatus, in response to communication being established with the transmitting section of the relay apparatus and reception of the second linkup code from the transmitting section of the relay apparatus.

3. The test apparatus according to claim 1, wherein
the transmitting section in each of the relay apparatus and the test unit transmits a serial signal to the communication apparatus at the other end, and
the receiving section in each of the relay apparatus and the test unit receives a serial signal from the communication apparatus at the other end.

4. The test apparatus according to claim 1, wherein
the transmitting section in each of the relay apparatus and the test unit transmits the second linkup code resulting from inserting, in a code having a pattern for establishing communication, a code having a pattern for transmitting information to the communication apparatus at the other end.

5. The test apparatus according to claim 4, wherein
the receiving section in each of the relay apparatus and the test unit suspends a process during a time period after establishing communication with the transmitting section of the communication apparatus at the other end and until receiving the second linkup code, and starts communicating with the transmitting section of the communication apparatus at the other end in response to reception of the second linkup code.

6. The test apparatus according to claim 5, wherein
the transmitting section of each of the relay apparatus and the test unit transmits, as the first linkup code and the second linkup code, a code using which a clock recovery process and a word alignment process can be performed at a receiving end, and
the receiving section of each of the relay apparatus and the test unit executes at least the clock recovery process and the word alignment process as the communication establishing process.

7. The test apparatus according to claim 6, wherein
the receiving section of each of the relay apparatus and the test unit transmits the first linkup code after a power supply is turned ON.
